(19) United States
(12) Patent Application Publication
(10) Pub. No.: US 2008/0292388 A1
(43) Pub. Date: Nov. 27, 2008

(54) Method and apparatus for recording, filing, indexing, & organizing print media

(76) Inventor: Karin Lea Davis, Olympia, WA (US)

Correspondence Address: Karin Lea Davis, 7125 101st Ave SW, Olympia, WA, 98512, US

(21) Appl. No.: 12/118,748

(22) Filed: May 11, 2008

Related U.S. Application Data
(60) Provisional application No. 60/917,505, filed on May 11, 2007.

(51) Int. Cl. B42F 3/00

(52) U.S. Cl. 402/70

(57) ABSTRACT

A new method and apparatus for recording, filing, indexing, & organizing print media that generally comprises a main print media storage binder having a multitude of binder rings, a multitude of sheet protectors, and a multitude of topic specific pre-printed indexing tabs which when compiled into a single system will allow a user to record, file, index, organize and otherwise manage print media such as magazine or newspaper articles or clippings in a secure, protective and easy to use system.

### BACKGROUND OF THE INVENTION

### Field of the Invention

This invention relates generally to the field of document or print media filing system Moreover it pertains specifically to a method and apparatus for recording, filing, indexing, & organizing print media within a storage device and system.

### SUMMARY OF THE INVENTION

In view of the limitations now present in the prior art, the present invention provides a new and useful method and apparatus for recording, filing, indexing, & organizing print media, which is simpler in construction, more universally usable and more versatile in operation than known device of this kind.

The purpose of the present invention is to provide a new method and apparatus for organizing and holding articles from magazines or newspapers in a secure manner, by means of inserting them into a transparent peel back sheet protector and inserting into a multi ring binder, which is utilized in conjunction with a multitude of pre-printed index tabs. It is also a purpose of the present invention to provide a new method and apparatus for organizing and holding articles from magazines or newspapers that has many novel features not offered by the prior art apparatus that result in a new method and apparatus for recording, filing, indexing, & organizing print media which is not apparent, obvious, or suggested, either directly or indirectly by any of the prior art apparatus.

The present invention in the preferred embodiment generally comprises a main print media storage binder having a multitude of binder rings, a multitude of sheet protectors, a multitude of pre-printed indexing tabs, and a media holding envelope. The storage binder is of a standard or usual type that contains planar, rigid front and back covers, a planar, rigid side cover that contains multiple binder document fastening rings which will act to secure the sheet protectors, wherein a user can insert a piece of print media such as a magazine or newspaper article by lifting the transparency covering portion of the sheet protectors and placing the selected print media onto the sheet protector and laying the transparency protector on top of the media, thereby securing the media in position on the sheet protector. A user can then choose from the multitude of pre-printed indexing tabs, selecting the appropriate heading tab and affixing it to the sheet protector, whereby the user can easily, at a later date, locate, review, and otherwise manage the print media.

The pre-printed indexing tabs will further allow a user to organize the print media to be filed within main categories as well as sub categories for efficient grouping and organizing of the print media. The media holding envelope is intended to provide the user with a holding or staging area for media that has yet to be filed. It is made, in the preferred embodiment, of a durable plastic material that will serve to store the media in a protective manner until the user can file it. The envelope can be affixed or adhered to the interior of the front binder cover, or can be affixed to binder ring holders that allow the envelope to be held in place by the binder rings.

It is to be understood that the present invention, by assembling all of the various components of the filing, indexing, and organizing system into a single complete kit, will save a user substantial time that would otherwise be spent gathering and assembling each of the individual components together. Additionally, the convenience of having “topic specific” pre-printed indexing tabs, will not only save the user time and cost associated with printing the tabs, it will also eliminate the need for a user to conceive and create the individual main groups, sub groups, or specialty groups of a specific topic.

It is to be further understood that the present invention may be offered in a variety of embodiments that can be used for the recording, filing, indexing, and or organizing of a variety of different print media topics including but not limited in use to, financial investment, home decorating, home repair, cooking, recipes, politics, specific sports, gardening, landscaping, collecting, antiques, vacation spots, travel subjects, shopping coupons, shopping comparison, health & wellness, as well as other topics of print media not referred to herein.

It is intended that the present invention can be offered with a set of pre-printed indexing tabs that correspond to any one of the print media topics disclosed herein as well as other topics contained in print media which can be recorded, filed, indexed, or organized by using the system and method disclosed herein and which are to be considered apparent and obvious extensions of the use of the system and method disclosed herein.

It is intended that the present invention can be offered with a set of pre-printed indexing tabs that correspond to any one of the print media topics disclosed herein as well as other topics contained in print media which can be recorded, filed, indexed, or organized by using the system and method disclosed herein and which are to be considered apparent and obvious extensions of the use of the system and method disclosed herein.

It is further intended that the present invention is not an attempt to claim novelty of any one of the specific components utilized or associated with the invention disclose herein, but to claim as new and novel the compilation of the separate individual pieces including the “topic specific” pre-printed indexing tabs, into a unified recording, filing, indexing, and organizing kit which is intended to be utilized as disclosed herein.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTIVES OF THE INVENTION

Accordingly several advantages and objects of the present invention are:

A principal objective of the present invention is to provide a Method and Apparatus for Recording, Filing, Indexing, & Organizing Print Media that will overcome the deficiencies of the prior art devices.

An objective of the present invention is to provide a Method and Apparatus for Recording, Filing, Indexing, & Organizing Print Media that provides a protective storage place for print media such as magazine or newspaper clippings or articles.

Another objective of the present invention is to provide a Method and Apparatus for Recording, Filing, Indexing, & Organizing Print Media that allows a user to organize similar print media or articles in one place.

Another objective of the present invention is to provide a Method and Apparatus for Recording, Filing, Indexing, & Organizing Print Media that allows a user to easily access and retrieve print media such as magazine or newspaper clippings or articles.

Another objective of the present invention is to provide a Method and Apparatus for Recording, Filing, Indexing, & Organizing Print Media that allows a user to separate print media such as magazine or newspaper clippings or articles into sub categories for filing, storage, and viewing purposes.

Another objective of the present invention is to provide a Method and Apparatus for Recording, Filing, Indexing, & Organizing Print Media that creates a faster organizing system with pre-printed titles of print media categories.

Another objective of the present invention is to provide a Method and Apparatus for Recording, Filing, Indexing, & Organizing Print Media that provides the user with multiple pre-printed subject headings for use within the filing system.

Another objective of the present invention is to provide a Method and Apparatus for Recording, Filing, Indexing, & Organizing Print Media that allows a user to easily and efficiently manage and update the print media within the filing system.

Another objective of the present invention is to provide a Method and Apparatus for Recording, Filing, Indexing, & Organizing Print Media that will provide a secure and protective environment.

Another objective of the present invention is to provide a Method and Apparatus for Recording, Filing, Indexing, & Organizing Print Media which is more versatile and compact than prior art devices.

It is intended that any other advantages and objectives of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention.

FIG. 1. is a front view of a binder portion of a Method and Apparatus for Recording, Filing, Indexing, & Organizing Print Media according to the present invention.

FIG. 2. is another front view of a binder portion of a Method and Apparatus for Recording, Filing, Indexing, & Organizing Print Media according to the present invention.

FIG. 3. is another front view of a binder portion of a Method and Apparatus for Recording, Filing, Indexing, & Organizing Print Media according to the present invention showing print media being inserted therein.

FIG. 4. is another front view of a sheet protector portion of a Method and Apparatus for Recording, Filing, Indexing, & Organizing Print Media according to the present invention showing print media being inserted therein

FIG. 5. is a front view of an index sheet portion of a Method and Apparatus for Recording, Filing, Indexing, & Organizing Print Media according to the present invention showing an index tab being inserted into a tab holder.

FIG. 6. is a front view of a sheet of index tabs of a Method and Apparatus for Recording, Filing, Indexing, & Organizing Print Media according to the present invention showing an index tab being inserted into a tab holder.

FIG. 7. is a front view of a closed binder portion of a Method and Apparatus for Recording, Filing, Indexing, & Organizing Print Media according to the present invention.

FIG. 8. is a front view of a sheet of index tabs and an index sheet components of a Method and Apparatus for Recording, Filing, Indexing, & Organizing Print Media according to the present invention.

### DETAILED DESCRIPTION OF THE DRAWINGS

Referring now, descriptively to the drawings, the attached figures illustrate a Method and Apparatus for Recording, Filing, Indexing, & Organizing Print Media.

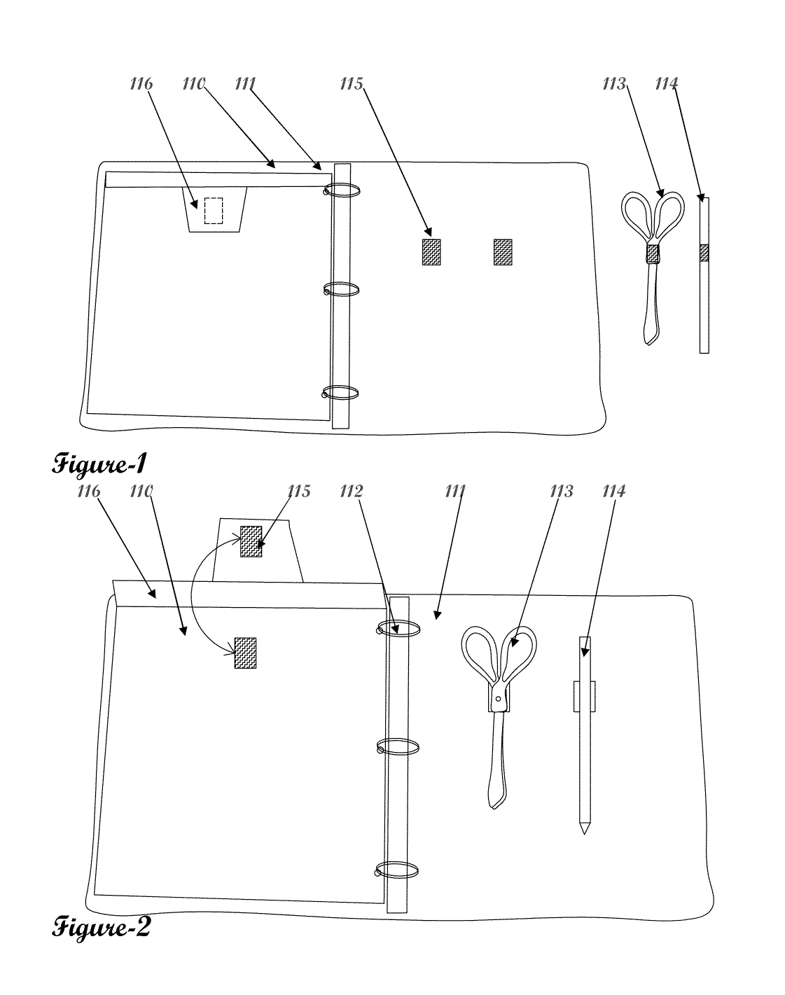

FIG. 1 illustrates the present invention (110) in the preferred embodiment showing a main print media storage binder (111) having a multitude of binder rings (112), cutting scissors (113), Writing utensil (114), Velcro fastening tabs (115), a closable media holding envelope (116), Binder mounted Velcro fastening tabs (117), illustrating the scissors and the writing utensil in the detached position, and the closable media holding envelope (116) in the closed position with the flap in the secured position.

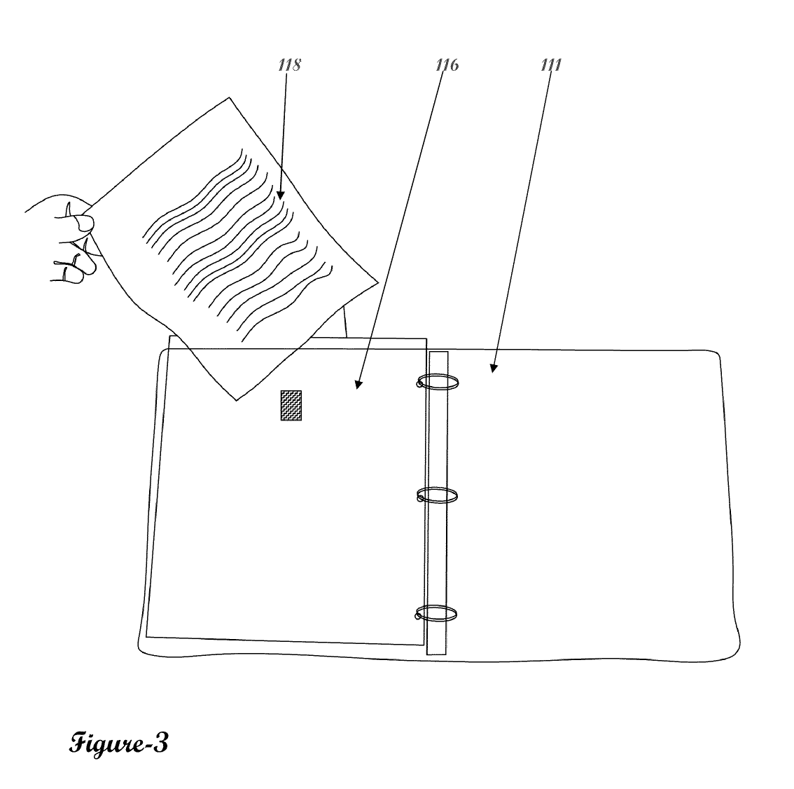

FIG. 2 illustrates the main print media storage binder (111) in the open position with the scissors (113) and writing utensil (114) attached to the inside cover of the binder (111), attached by means of the Velcro fastening tabs (117), and further showing the closable media holding envelope (116) in the open position.

FIG. 3 illustrates the main print media storage binder (111) in the open position with the closable media holding envelope (116) in the open position attached to the binder rings (112), with a piece of media (118) being inserted into the closable media holding envelope (116).

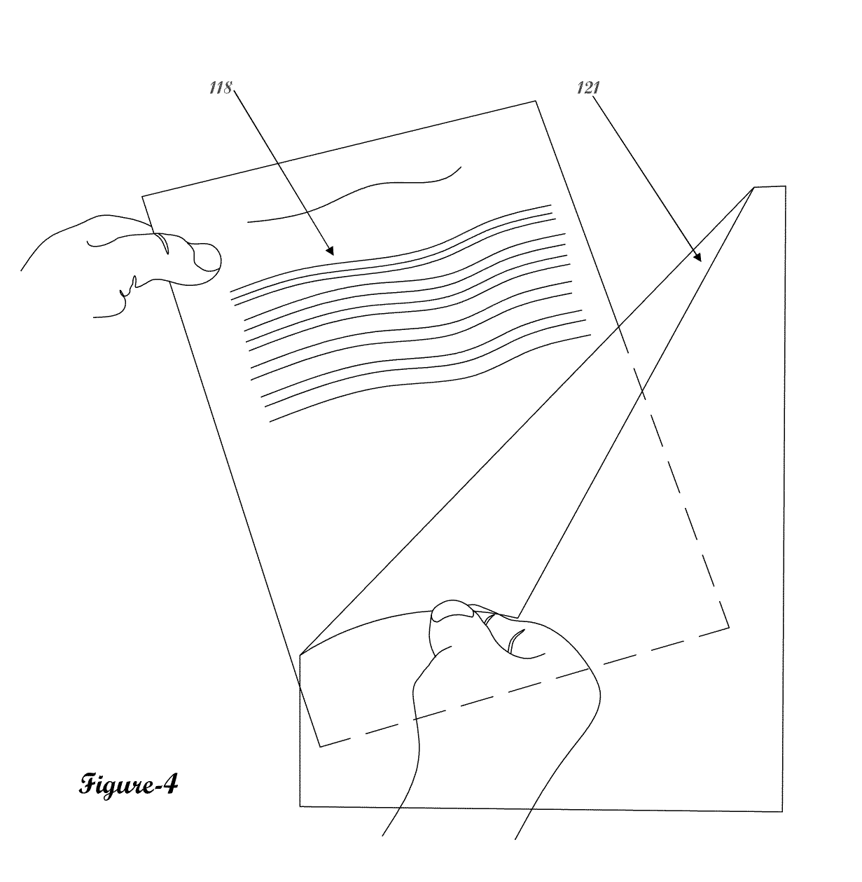

FIG. 4 illustrates a sheet of media (118) being inserted into a sheet protector (121) that is simply pulled back to reveal the interior surface and then closed once the print media (118) is inserted therein.

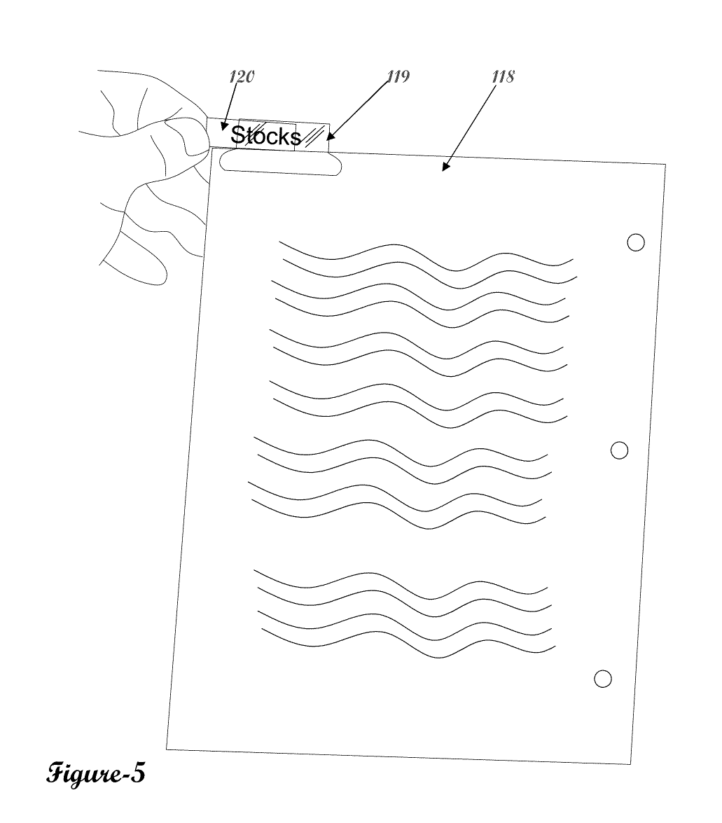

FIG. 5 illustrates a pre-printed indexing tab being inserted into a tab holder (119) which is attached to an index sheet or a sheet of print media (118) which is hole punched for insertion into the main print media binder (111).

### DETAILED DESCRIPTION OF THE DRAWINGS

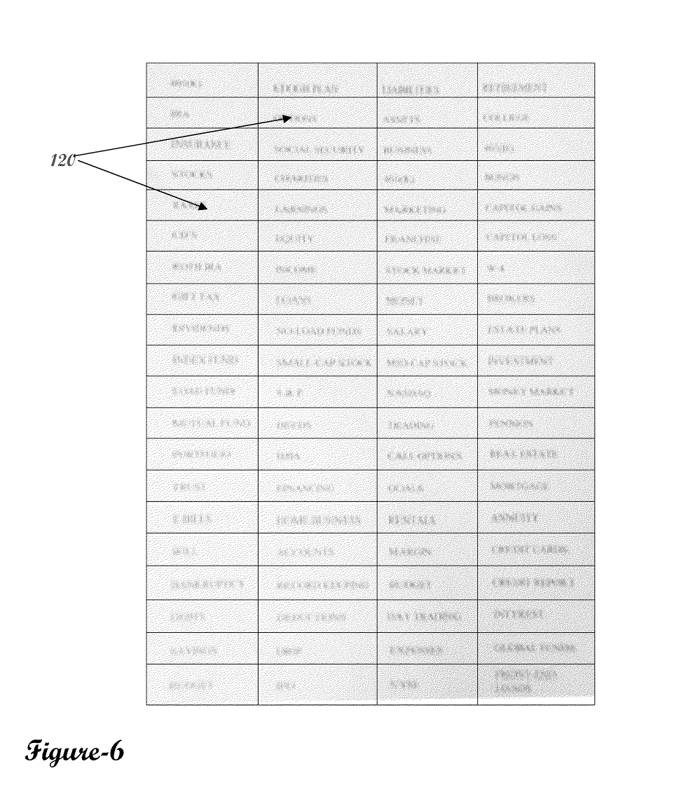

FIG. 6 illustrates a full sheet of pre-printed index tabs (120) which are used within the system disclosed herein to identify print media associated with a specific group or type of media.

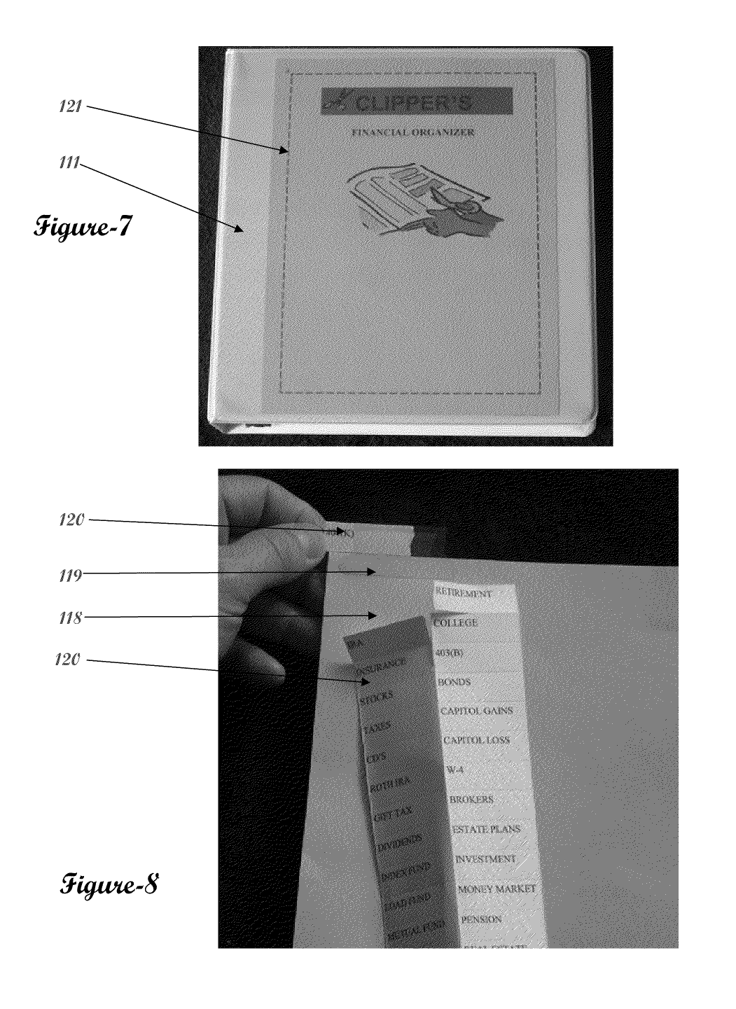

FIG. 7 illustrates the main print media binder (111) in the closed position with a group or category identifying sheet (121) inserted into the front cover sheet protector of the binder (111).

FIG. 8 illustrates a multitude of pre-printed index tabs, with one tab being inserted into a tab holder which is attached to an index page to indicate the separation of a category within the binder.

I claim:

1. A print media recording, filing, indexing, & organizing apparatus and method of use that comprises a main print media storage binder having a multitude of binder rings, a multitude of sheet protectors, a multitude of pre-printed indexing tabs, media cutting scissors, media identifying writing utensil, and a media holding envelope.

2. The apparatus and method of claim 1 wherein the index tabs are pre-printed.

3. The apparatus and method of claim 1 wherein the index tabs are pre-printed and compiled into specific groups or categories including financial investment, home decorating, home repair, cooking, recipes, politics, specific sports, gardening, landscaping, collecting, antiques, vacation spots, travel subjects, shopping coupons, shopping comparison, health & wellness.

4. The apparatus and method of claim 1 wherein the index tabs can be generated by computer software by the user.
